(19) United States
(12) Patent Application Publication
(10) Pub. No.: US 2008/0052089 A1
(43) Pub. Date: Feb. 28, 2008

(54) Acoustic Signal Encoding Device and Acoustic Signal Decoding Device

(75) Inventor: Yoshiaki Takagi, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/570,471

(22) PCT Filed: Jun. 13, 2005
(86) PCT No.: PCT/JP05/10811

§ 371 Date: Dec. 12, 2006

(30) Foreign Application Priority Data
Jun. 14, 2004 (JP) 2004-175656

(51) Int. Cl. G10L 21/04

(52) U.S. Cl. 704/503; 704/E19.023

(57) ABSTRACT

Herein disclosed is an acoustic signal encoding device comprising: a coefficient table (17) having described therein coefficients representable in the form of a matrix with 2 rows by N columns simulating head-related transfer characteristics to be applied when a multi-channel signal is reproduced, a first signal outputting unit (12) for downmixing a N-channel frequency domain signal to have a 2-channel downmixed signal outputted therethrough in accordance with the coefficient table (17), and a second signal outputting unit (14) for generating subsidiary information to be used to reconstruct a multi-channel signal based on the 2-channel downmixed signal, thereby making it possible for the downmixed signal to be filtered in accordance with a desired transfer function, and thus enabling the acoustic signal decoding device to reproduce the original multi-channel spatial information simply by reproducing the first coded signal, and the original multi-channel signal by reproducing the first coded signal with the aid of the second coded signal.

### TECHNICAL FIELD OF THE INVENTION

The present invention relates to an acoustic signal encoding device for encoding a multi-channel signal and an acoustic signal decoding device for decoding a coded signal.

### DESCRIPTION OF THE RELATED ART

Up until now, there have been researched and developed a wide variety of an acoustic encoder, hereinlater referred to as “acoustic signal encoding device”, for generating coded signals to be later reproduced into a multi-channel signal by a 2-channel reproducing device connected with an inexpensive reproducing device such as, for example, a head phone. Processes of converting a multi-channel signal into a signal less in the number of channels than the multi-channel signal is generally referred to as “downmixing process” or “downmixing”. In recent years, there have been researched and developed as one example of the acoustic devices of this type a multi-channel encoder and a multi-channel decoder in conformity with MPEG 2 Audio Standard (ISO 13818-3). The multi-channel encoder is designed to downmix multi-channel signals L, R, l, and r into 2-channel signals L0, R0, which will be encoded and outputted as “first coded signals”, to be used to ensure that the multi-channel signals L, R, l, and r can be reproduced through, for example, a pair of speaker units, a head phone, or the like, and signals l0, r0, which will be encoded and outputted as “second coded signals”, to be used to reconstruct the multi-channel signals based on the downmixed signals L0, R0, by performing the computation represented by Expression 1 as follows.

$$\{ \begin{matrix}L 0 = L + l \\ R 0 = R + r \\ l 0 = - l \\ r 0 = - r\end{matrix} \qquad Expression 1$$

Here, L, R, l, and r are intended to mean signals respectively outputted from a left front speaker unit, a right front speaker unit, a left rear speaker unit, and a right rear speaker unit.

There is, on the other hand, provided a conventional inexpensive 2-channel signal decoding device, which is operative decode the aforementioned first coded signals L0, R0, only, and a conventional multi-channel decoding device, which is operative to decode the aforementioned original multi-channel signals L, R, l, and r based on the first coded signals L0, R0, and the second coded signals l0, r0, by performing the computation represented by Expression 2 as follows.

$$\{ \begin{matrix}L = L 0 + l 0 \\ R = R 0 + r 0 \\ l = - l 0 \\ r = - r 0\end{matrix} \qquad Expression 2$$

Further, there are provided a multi-channel encoder for encoding an inputted multi-channel signal into two sub-streams including a first sub-stream constituted by downmixed 2-channel signals L0, R0, and a second sub-stream constituted by signals lo, r0, to be used to reconstruct the multi-channel signals based on the downmixed signals L0, R0, and multiplexing the first sub-stream and the second sub-stream into one stream, and a multi-channel decoder for demultiplexing the stream into the first sub-stream and the second sub-stream, decoding the first sub-stream into the downmixed 2-channel signals L0, R0, to be used to ensure that the multi-channel signals L, R, l, and r can be reproduced through, for example, a pair of speaker units, a head phone, or the like, as well as enabling to decode the downmixed 2-channel signals L0, R0 into the original multi-channel signal using the second sub-stream constituted by signals l0, r0 (see, for example, Patent Document 1).

FIG. 7 is a block diagram showing a conventional acoustic signal decoding device forming part of the conventional 2-channel decoder, which is operative to reproduce the downmixed 2-channel signal, or the multi-channel decoder. Here, the term “downmixed signal” is intended to mean a signal produced as a result of downmixing a multi-channel signal having a predetermined number of channels, and therefore having channels less in the number than the multi-channel signal.

As shown in FIG. 7, the conventional acoustic signal decoding device 70 comprises a demultiplexing unit 71 for demultiplexing a bit stream B into a downmixed coded signal and a subsidiary information coded signal, a first decoding unit 72 for decoding the downmixed coded signal into 2-channel frequency domain acoustic signals constituted by downmixed signals L0, R0, a second decoding unit 73 for decoding the aforementioned subsidiary coded signal into subsidiary information l0, r0, an upmixing unit 74 for reconstructing a multi-channel signal based on the downmixed signals L0, R0 and the subsidiary information l0, r0, a frequency-time converting unit 75 for converting the reconstructed multi-channel signal into time domain acoustic signals L′, R′, l′, r′, a coefficient table 76 having described therein coefficients representable in the form of an inverse square matrix of a square matrix with N rows by N columns including coefficients representable in the form of a matrix with 2 rows by N columns simulating head-related transfer characteristics to be applied when the multi-channel signal is reproduced, and a head-related transfer characteristics simulating unit 77 for spatial-filtering the time domain acoustic signal converted by the frequency-time converting unit 75 in accordance with the coefficient table 76, into generate 2-channel acoustic signals L1, R1. The head-related transfer characteristics simulating unit 77 is operative to synthesize the time domain acoustic signals L′, R′, l′, r′ and the coefficients to generate the 2-channel acoustic signals L1, R1 with high quality which make it possible for, for example, a head phone, or the like, to reproduce spatial information as well as acoustic information.
Patent Document 1: Japanese Translation of PCT International Application 2002-541524

### DISCLOSURE OF THE INVENTION

### Problems to be Solved by the Invention

The decoded downmixed signal, however, lacks the spatial information of the original multi-channel signal, because of the fact that the signal downmixed in conformity with the MPEG-2 Audio Standard is generated by performing predetermined matrix computation for each of sample time periods. This means that the multi-channel signals decoded from the first coded signals L0, R0 with the second coded signals l0, r0 is required to be further spatial-filtered by the head-related transfer characteristics simulating unit 77 in accordance with the coefficient table 76 as described in the conventional acoustic signal decoding device, in order to enable a receiving side to reproduce the 2-channel signal with high quality, viz., the 2-channel signal having original spatial information, i.e., virtual surround information, thereby being increased on computations caused by the filtering processes.

The present invention is made for the purpose of overcoming the aforementioned problems and it is an object of the present invention to provide an acoustic signal encoding device for generating coded information which enables a receiving side to reproduce the original multi-channel spatial information simply by reproducing the downmixed signal, and an acoustic signal decoding device for reproducing the original multi-channel spatial information simply by reproducing the downmixed signal from the coded information.

### Means for Solving the Problems

In accordance with a first aspect of the present invention, there is provided an acoustic signal encoding device, comprising: time-frequency converting means for converting an N-channel signal into an N-channel frequency domain signal; first signal outputting means for downmixing said N-channel frequency domain signal to have a 2-channel downmixed signal outputted therethrough; second signal outputting means for generating subsidiary information to be used to reconstruct a multi-channel signal based on said 2-channel downmixed signal; first encoding means for encoding said downmixed signal to generate a first coded signal; second encoding means for encoding said subsidiary information to generate a second coded signal; multiplexing means for multiplexing said first coded signal and said second coded signal; and a coefficient table for having described therein coefficients for respective frequencies collectively indicative of transfer characteristics, and in which said N is an integer equal to or greater than three, said coefficient table includes a square matrix with N rows by N columns formed by coefficients representable in the form of a matrix with 2 rows by N columns simulating head-related transfer characteristics to be applied when said multi-channel signal is reproduced and values aligned in the form of a matrix with (N−2) rows by N columns, which are generated after sign-reversing and realigning said coefficients representable in the form of a matrix with 2 rows by N columns, said first signal outputting means is operative to downmix said N-channel frequency domain signal into said 2-channel downmixed signal in accordance with said coefficient table, and said second signal outputting means is operative to generate said subsidiary information to be used to reconstruct based on said 2-channel downmixed signal, in accordance with said coefficient table.

The acoustic signal encoding device according to the present invention thus constructed as previously mentioned makes it possible for a downmixed signal to be filtered in accordance with a desired transfer function, thereby enabling the acoustic signal decoding device to reproduce the original multi-channel spatial information simply by reproducing the first coded signal, and the original multi-channel signal by reproducing the first coded signal with the aid of the second coded signal.

Further, the aforementioned acoustic signal encoding device according to the present invention may comprise: a plurality of coefficient tables for having described therein coefficients for respective frequencies collectively indicative of a plurality of transfer characteristics different from one another, and coefficient table selecting means for selecting a coefficient table from among a plurality of coefficient tables in response to a usage, and in which said multiplexing means may be operative to multiplex index information indicative of said coefficient table selected by said coefficient table selecting means, in addition to said first coded signal and said second coded signal.

The acoustic signal encoding device according to the present invention thus constructed as previously mentioned can transfer to a decoding device a specific type of a coefficient required to reproduce the multi-channel signal when the multi-channel signal is reproduced, with a small number of bits, resulting from the fact that the acoustic signal encoding device according to the present invention can select a coefficient table in response to a usage, and multiplex the index information indicative of the selected coefficient table.

In accordance with a second aspect of the present invention, there is provided an acoustic signal decoding device, comprising: an acoustic signal decoding device, comprising: demultiplexing means for demultiplexing a bit stream generated by said acoustic signal encoding device to exclusively extract downmixed codes; decoding means for decoding said downmixed codes into a 2-channel frequency domain acoustic signal; and frequency-time converting means for converting said frequency domain acoustic signal into a time domain acoustic signal.

The acoustic signal encoding device according to the present invention thus constructed as previously mentioned can reproduce the downmixed signal with a small amount of computation, resulting from the fact that the acoustic signal encoding device is operative to exclusively extract and decode the downmixed signal to generate a 2-channel frequency domain acoustic signal, without decoding the subsidiary information.

Further, the aforementioned acoustic signal decoding device according to the present invention may comprise demultiplexing means for demultiplexing a bit stream generated by any one of aforementioned acoustic signal encoding devices to extract downmixed codes and subsidiary information codes; first decoding means for decoding said downmixed codes into a 2-channel frequency domain acoustic signal as a downmixed signal; second decoding means for decoding said subsidiary information codes into subsidiary information; upmixing means for generating a multi-channel signal based on said downmixed signal and said subsidiary information; frequency-time converting means for converting said multi-channel signal into a time domain acoustic signal; and a coefficient table for having described therein coefficients representable in the form of an inverse square matrix of a square matrix with N rows by N columns including coefficients representable in the form of a matrix with 2 rows by N columns simulating head-related transfer characteristics to be applied when said multi-channel signal is reproduced, and in which said upmixing means may be operative to generate said multi-channel signal in accordance with said coefficient table.

The acoustic signal encoding device according to the present invention thus constructed as previously mentioned can reproduce the original multi-channel signal even though the downmixed signal contains transfer characteristics, resulting from the fact that the demultiplexing means is operative to extract downmixed codes and subsidiary information codes from the bit stream, and the upmixing means is operative to generate the multi-channel signal based on the downmixed signal and subsidiary information in accordance with the coefficient table which is an inverse square matrix of a matrix simulating the head-related transfer characteristics.

Further, the aforementioned acoustic signal decoding device may comprise outputting channel switching means for selectively outputting said downmixed signal and said multi-channel signal, and in which, said frequency-time converting means is operative to convert said signal selectively outputted from outputting channel switching means into a time domain acoustic signal.

The acoustic signal encoding device according to the present invention thus constructed as previously mentioned can reproduce both the 2-channel downmixed signal and the multi-channel signal with the same constituent elements, resulting from the fact that the acoustic signal encoding device is operative to selectively output the 2-channel downmixed signal and the multi-channel signal, and generate a frequency domain acoustic signal based on the outputted signal.

Further, in the aforementioned acoustic signal decoding device, said coefficient table may include coefficients simulating spatial transfer characteristics.

The acoustic signal encoding device according to the present invention thus constructed as previously mentioned can reproduce the 2-channel signal having appropriate virtual surrounding information in accordance with the size of a room, for example, in the case that two speaker units are used in the room.

### EFFECT OF THE PRESENT INVENTION

The present invention provides an acoustic signal encoding device which comprises first signal outputting means for downmixing an N-channel frequency domain signal to have a 2-channel downmixed signal outputted therethrough, second signal outputting means for generating subsidiary information to be used to reconstruct a multi-channel signal based on the 2-channel downmixed signal, multiplexing means for multiplexing a first coded signal generated as a result of encoding the downmixed signal, and a second coded signal generated as a result of encoding the subsidiary information, and a coefficient table for having described therein coefficients for respective frequencies collectively indicative of transfer characteristics, and in which the N is an integer equal to or greater than three, and the first signal outputting means and the second signal outputting means are operative to generate respective signals in accordance with the coefficient table, and an acoustic signal decoding device. This results in the fact that the acoustic signal encoding device according to the present invention makes it possible for a downmixed signal to be filtered in accordance with a desired transfer function, thereby enabling the acoustic signal decoding device to reproduce the original multi-channel spatial information simply by reproducing the first coded signal, and the original multi-channel signal by reproducing the first coded signal with the aid of the second coded signal.

### BRIEF DESCRIPTION OF THE DRAWINGS

The features and advantages of an acoustic signal encoding device and an acoustic signal decoding device according to the present invention will be more clearly understood from the following description taken in conjunction with the accompanying drawings in which:

FIG. 1 is a block diagram showing a first preferred embodiment of the acoustic signal encoding device according to the present invention;

FIG. 2 is a layout drawing of a listener and speaker units for explaining a head-related transfer function.

FIG. 3 is a block diagram showing a second preferred embodiment of the acoustic signal encoding device according to the present invention;

FIG. 4 is a block diagram showing a third preferred embodiment of the acoustic signal decoding device according to the present invention;

FIG. 5 is a block diagram showing a fourth preferred embodiment of the acoustic signal decoding device according to the present invention;

FIG. 6 is a block diagram showing a fifth preferred embodiment of the acoustic signal decoding device according to the present invention; and

FIG. 7 is a block diagram showing a conventional acoustic signal decoding device for reproducing spatial information based on conventional coded signals.

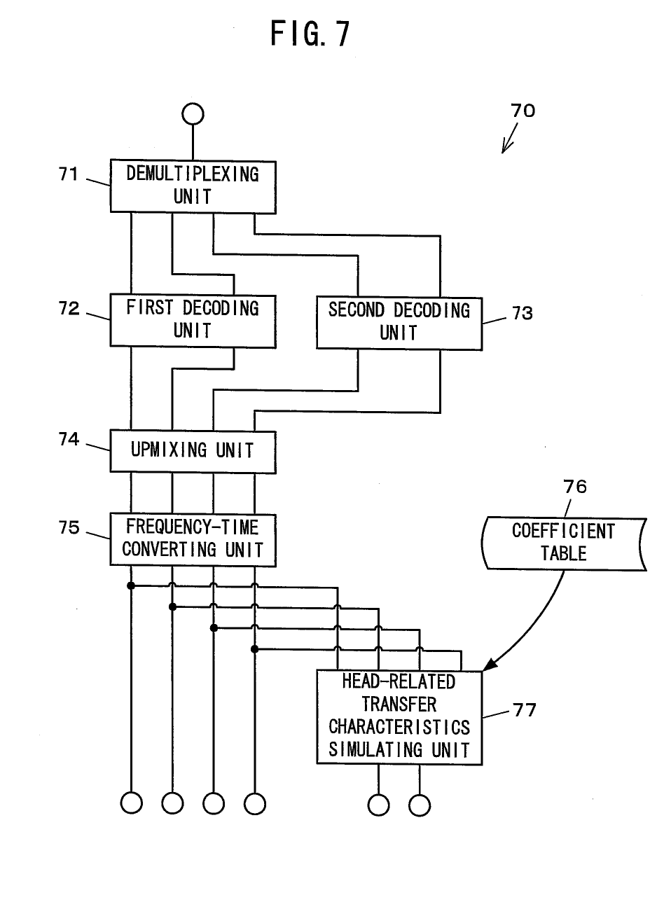

### DESCRIPTION OF THE REFERENCE NUMERALS

10, 20 acoustic signal encoding device
11, 21 time-frequency converting unit
12, 22 first signal outputting unit
13, 23 first encoding unit
14, 24 second signal outputting unit
15, 25 second encoding unit
16, 29 multiplexing unit
17, 27 a plurality of coefficient tables
26 coefficient table selecting unit
28 third encoding unit
30, 40, 50 acoustic signal decoding device
31, 41, 51 demultiplexing unit
32 decoding unit
33, 45, 56 frequency-time converting unit
42, 52 first decoding unit
43, 53 second decoding unit
44, 54 upmixing unit
46, 57 coefficient table
55 outputting channel switching unit
61 left front speaker unit
62 right front speaker unit
63 left rear speaker unit
64 right rear speaker unit
65 head of a listener
70 acoustic signal decoding device
71 demultiplexing unit
72 first decoding unit
73 second decoding unit
74 upmixing unit
75 frequency-time converting unit
76 coefficient table
77 head-related transfer characteristics simulating unit

### BEST MODE FOR CARRYING OUT THE INVENTION

Preferred embodiments of the acoustic signal encoding device and the acoustic signal decoding device according to the present invention will be described hereinafter with reference to the drawings.

### First Preferred Embodiment

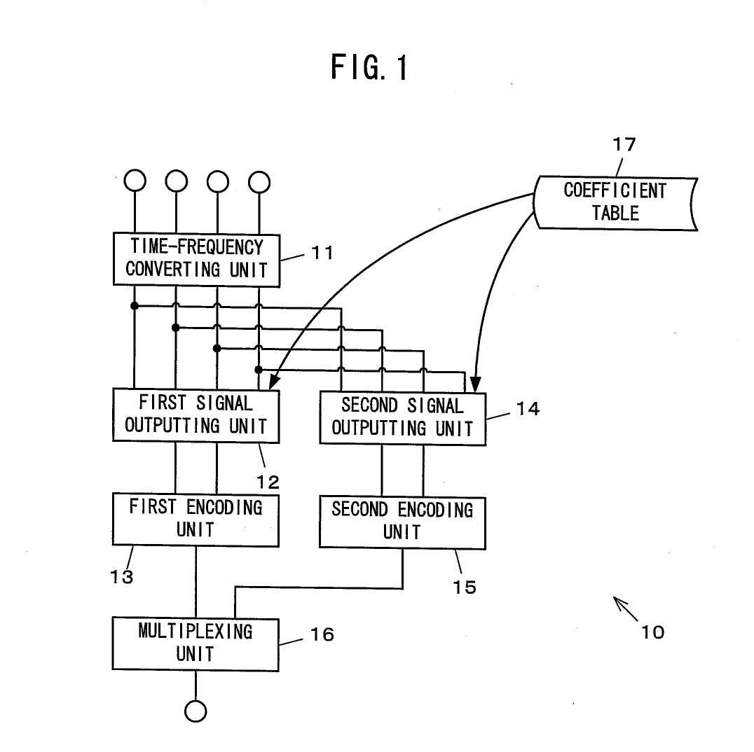

The construction of a first preferred embodiment of the acoustic signal encoding device according to the present invention will be described first with reference to FIG. 1 of the drawings.

As clearly shown in FIG. 1, the present embodiment of the acoustic signal encoding device 10 comprises a time-frequency converting unit 11 for converting a multi-channel signal constituted by an N-channel signal into an N-channel frequency domain signal, a first signal outputting unit 12 for downmixing the N-channel frequency domain signal to generate a 2-channel downmixed signal, a first encoding unit 13 for encoding the downmixed signal to generate a first coded signal, a second signal outputting unit 14 for generating subsidiary information to be used to reconstruct a multi-channel signal based on the downmixed signal, a second encoding unit 15 for encoding the subsidiary information to generate a second coded signal, a multiplexing unit 16 for multiplexing the first coded signal and the second coded signal, and a coefficient table 17 having described therein coefficients for respective frequencies collectively indicative of transfer characteristics. It is herein assumed that N is an integer equal to or greater than three, and the coefficient table 17 is stored in a storage medium such as, for example, a memory, not shown.

The operation of the acoustic signal encoding device 10 thus constructed as previously mentioned will be described hereinlater. It is hereinlater assumed that the multi-channel signal constituted by N-channel signal is composed of four signals including a left front acoustic signal L, a right front acoustic signal R, a left rear acoustic signal l and a right rear acoustic signal r.

The time-frequency converting unit 11 is operated to convert 4-channel signals, L, R, l, and r into 4-channel frequency domain signals respectively by way of, for example, a Fourier Transformation, a Discrete Cosine Transformation, a sub-band filter, and/or the like.

The first signal outputting unit 12 is operated to downmix the 4-channel frequency domain signal to generate a 2-channel downmixed signal by performing the computation represented by Expression 3 in accordance with the coefficients stored in the coefficient table 17, as follows.

$$[ \begin{matrix}a & c & b & d \\ c & a & d & b\end{matrix} ] [ \begin{matrix}L \\ R \\ l \\ r\end{matrix} ] = [ \begin{matrix}aL + cR + bl + dr \\ cL + aR + dl + br\end{matrix} ] \qquad Expression 3$$

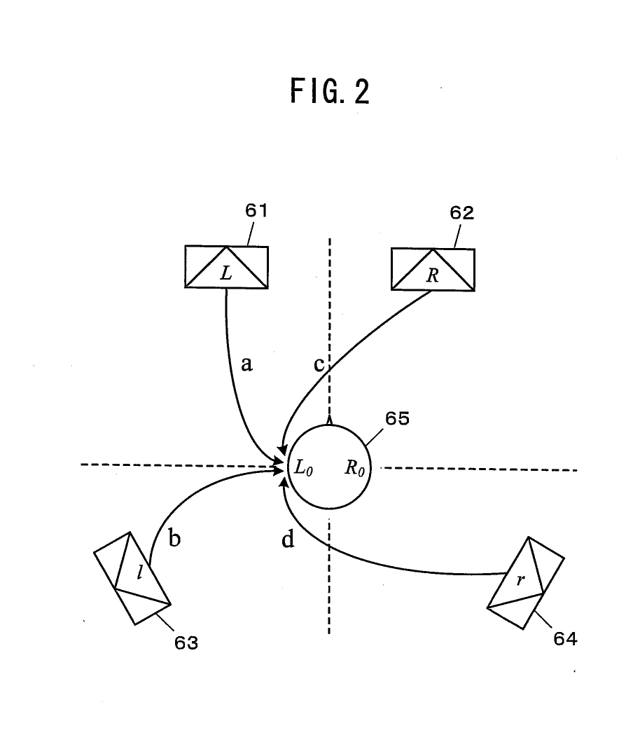

Here, the coefficients a, b, c, d represented in the form of a matrix with 2 rows by N columns are intended to mean a head-related transfer function simulating head-related transfer characteristics shown in FIG. 2.

In FIG. 2, it is assumed that a left front speaker unit 61, a right front speaker unit 62, a left rear speaker unit 63, and a right rear speaker unit 64 are disposed in the vicinity of a head of a listener denoted by a reference numeral 65. Here, L is intended to means a signal outputted from the left front speaker unit 61, R is intended to means a signal outputted from the right front speaker unit 62, l is intended to means a signal outputted from the left rear speaker unit 63, r is intended to means a signal outputted from the right rear speaker unit 64, Le is intended to mean a signal reaching a left ear of the listener, and Re is intended to mean a signal reaching a right ear of the listener.

The coefficient a is intended to mean a transfer function simulating a transfer characteristics from the left front speaker unit 61 to the left ear of the listener, the coefficient b is intended to mean a transfer function simulating a transfer characteristics from the left rear speaker unit 63 to the left ear of the listener, the coefficient c is intended to mean a transfer function simulating a transfer characteristics from the right front speaker unit 62 to the left ear of the listener, and the coefficient d is intended to mean a transfer function simulating a transfer characteristics from the right rear speaker unit 64 to the left ear of the listener. The coefficients a, b, c, and d collectively constitute a “head-related transfer function”.

Returning to the description of the operation of the acoustic signal encoding device 10, the first encoding unit 13 is operated to encode the downmixed signals L0, R0 outputted from the first signal outputting unit 12, to generate a first coded signal. The first encoding unit 13 may encode the downmixed signals by way of a coding method such as, for example, an MPEG 2 Standard.

The second signal outputting unit 14 is operated to generate subsidiary information l0, r0 by performing the computation represented by Expression 4 in accordance with the coefficients stored in the coefficient table 17, as follows. The subsidiary information l0, r0 will be used to reconstruct a multi-channel signal based on the downmixed signal.

$$[ \begin{matrix}a & c - b & - d \\ c & a - d & b\end{matrix} ] [ \begin{matrix}L \\ R \\ l \\ r\end{matrix} ] = [ \begin{matrix}aL + cR - bl - dr \\ cL + aR - dl + br\end{matrix} ] \qquad Expression 4$$

Here, the coefficients a, b, c, d are represented in the form of a matrix with (N−2) rows by N columns. In the present embodiment, the coefficients a, b, c, d are represented in the form of a matrix with 2 rows by N columns.

The second encoding unit 15 is operated to encode the subsidiary information l0, r0 outputted from the second signal outputting unit 14, to generate a second coded signal. The second encoding unit 15 may encode the subsidiary information by way of a coding method such as, for example, the MPEG 2 Standard in the same manner as the first encoding unit 13.

The multiplexing unit 16 is operated to multiplex the first coded signal generated by the first encoding unit 13 and the second coded signal generated by the second encoding unit 15 to generate a bit stream B.

Information of the bit stream B can be represented by Expression 5 of determinant as follows.

$$[ \begin{matrix}a & c & b & d \\ c & a & d & b \\ a & c & - b & - d \\ c & a & - d & b\end{matrix} ] [ \begin{matrix}L \\ R \\ l \\ r\end{matrix} ] = [ \begin{matrix}aL + cR + bl + dr \\ cL + aR + dl + br \\ aL + cR - bl - dr \\ cL + aR - dl + br\end{matrix} ] \qquad Expression 5$$

Hf is defined as represented by Expression 6 as follows.

$$Hf = [ \begin{matrix}Af & Cf & Bf & Df \\ Cf & Af & Df & Bf \\ Af & Cf & - Bf & - Df \\ Cf & Af & - Df & Bf\end{matrix} ] \qquad Expression 6$$

Expression 7 is obtained as follows.

$${H}^{′} f = [ \begin{matrix}Af \cdot Xf & - Cf \cdot Xf & Af \cdot Xf & - Cf \cdot Xf \\ - Cf \cdot Xf & Af \cdot Xf & - Cf \cdot Xf & Af \cdot Xf \\ Bf \cdot Yf & - Df \cdot Yf & - Bf \cdot Yf & Df \cdot Yf \\ - Df \cdot Yf & Bf \cdot Yf & - Df \cdot Yf & - Bf \cdot Yf\end{matrix} ] \qquad Expression 7$$

The fact that the inverse matrix of Expression 8 exists leads to the fact that the original four-channel signals L, R, l, and r can be extracted in accordance with the Expression 9 as follows.

$$\begin{matrix}Xf = \frac{1}{2 ( {Af}^{2} - {Cf}^{2} )} \\ Yf = \frac{1}{2 ( {Bf}^{2} - {Df}^{2} )} & Expression 8 \\ [ \begin{matrix}L \\ R \\ l \\ r\end{matrix} ] = [ \begin{matrix}ax & - cx & ax & - cx \\ - cx & ax & - cx & ax \\ by & - dy & - by & dy \\ - dy & by & dy & - by\end{matrix} ] [ \begin{matrix}L 0 \\ R 0 \\ l \\ r\end{matrix} ] & Expression 9\end{matrix}$$

Here, X and y can be represented by Expression 10 as follows.

$$x = \frac{1}{2 ( {a}^{2} - {c}^{2} )} \\ y = \frac{1}{2 ( {b}^{2} - {d}^{2} )} \qquad Expresssion 10$$

As will be seen from the foregoing description, it will be understood that the present embodiment of the acoustic signal encoding device according to the present invention comprises a coefficient table 17 having described therein coefficients represented in the form of a matrix with 2 rows by N columns simulating head-related transfer characteristics, a first signal outputting unit 12 for downmixing a N-channel frequency domain signal in accordance with the coefficient table 17 to generate a first coded signal constituted by a 2-channel downmixed signal, and a second signal outputting unit 14 for generating a second coded signal constituted by subsidiary information to be used to reconstruct a multi-channel signal based on the downmixed signal. This results in the fact that the present embodiment of the acoustic signal encoding device according to the present invention makes it possible for a downmixed signal to be filtered in accordance with a desired transfer function, thereby enabling the acoustic signal decoding device to reproduce the original multi-channel spatial information simply by reproducing the first coded signal, and the original multi-channel signal by reproducing the first coded signal with the aid of the second coded signal.

### Second Preferred Embodiment

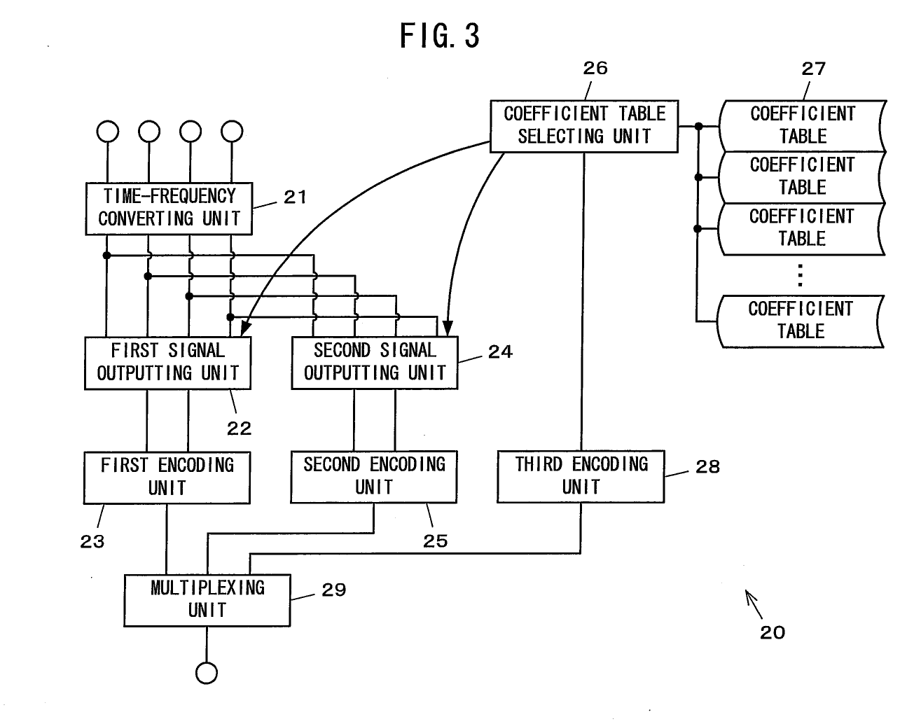

The construction of a second preferred embodiment of the acoustic signal encoding device according to the present invention will be described first with reference to FIG. 3 of the drawings.

As clearly shown in FIG. 3, the present embodiment of the acoustic signal encoding device 20 comprises a time-frequency converting unit 21 for converting a multi-channel signal constituted by an N-channel signal into an N-channel frequency domain signal, a first signal outputting unit 22 for downmixing the N-channel frequency domain signal to generate a 2-channel downmixed signal, a first encoding unit 23 for encoding the downmixed signal to generate a first coded signal, a second signal outputting unit 24 for generating subsidiary information to be used to reconstruct a multi-channel signal based on the downmixed signal, a second encoding unit 25 for encoding the subsidiary information to generate a second coded signal, a coefficient table selecting unit 26 for selecting a coefficient table indicative of a transfer function to be used for the first signal outputting unit 22 and the second signal outputting unit 24 in accordance with an intended usage, a plurality of coefficient tables 27 each having described therein coefficients for respective frequencies collectively indicative of transfer characteristics, a third encoding unit 28 for generating a third coded signal to be used as an index indicative of the coefficient table selected by the coefficient table selecting unit 26, and a multiplexing unit 29 for multiplexing the first coded signal, the second coded signal, and the third coded signal. It is herein assumed that N is an integer equal to or greater than three, and the coefficient tables 27 are stored in a storage medium such as, for example, a memory, not shown. Further, the time-frequency converting unit 21, the first signal outputting unit 22, the first encoding unit 23, the second signal outputting unit 24, and the second encoding unit 25 are, respectively, the same as the time-frequency converting unit 11, the first signal outputting unit 12, the first encoding unit 13, the second signal outputting unit 14, and the second encoding unit 15 described in the first embodiment.

The operation of the acoustic signal encoding device 20 thus constructed as previously mentioned will be described hereinlater. It is hereinlater assumed that the multi-channel signal constituted by N-channel signal is composed of four signals including a left front acoustic signal L, a right front acoustic signal R, a left rear acoustic signal l and a right rear acoustic signal r.

The time-frequency converting unit 21 is operated to convert 4-channel signals, L, R, l, and r into 4-channel frequency domain signals respectively by way of, for example, a Fourier Transformation, a Discrete Cosine Transformation, a sub-band filter, and/or the like.

The coefficient table selecting unit 26 is operated to select a coefficient table indicative of a transfer function indicative of transfer characteristics to be simulated by the first signal outputting unit 22, from among a plurality of coefficient tables 27. The plurality of coefficient tables 27 includes various kinds of coefficients simulating head-related transfer characteristics when the multi-channel signal is reproduced. These plurality of coefficient tables 27 permit the coefficient table selecting unit 26 to select an appropriate coefficient table in accordance with a head size of a listener operating a head phone, two speaker units, or the like, thereby enabling a receiving side to reproduce the 2-channel signal having appropriate virtual surrounding information, regardless of whether the listener is an adult or a child. Further, the plurality of coefficient tables 27 may include spatial transfer coefficients simulating spatial transfer characteristics in a space where the listener listens to sounds outputted from the speaker units, in addition to the head-related transfer coefficients simulating the head-related transfer characteristics. These plurality of coefficient tables 27 enable a receiving side to reproduce the 2-channel signal having appropriate virtual surrounding information in accordance with the size of a room, for example, in the case that two speaker units are used in the room.

The first signal outputting unit 22 is operated to downmix the 4-channel frequency domain signal converted by the time-frequency converting unit 21 to generate a 2-channel downmixed signal by performing the computation represented by Expression 11 in accordance with the coefficients stored in the coefficient table selected by the coefficient table selecting unit 26 from among the plurality of coefficient tables 27, as follows.

$$[ \begin{matrix}a & c & b & d \\ c & a & d & b\end{matrix} ] [ \begin{matrix}L \\ R \\ l \\ r\end{matrix} ] = [ \begin{matrix}aL + cR + bl + dr \\ cL + aR + dl + br\end{matrix} ] \qquad Expression 11$$

Here, the coefficients a, b, c, d are represented in the form of a matrix with 2 rows by N columns.

The first encoding unit 23 is operated to encode the downmixed signals outputted from the first signal outputting unit 22, to generate a first coded signal. The first encoding unit 23 may encode the downmixed signals by way of a coding method such as, for example, an MPEG 2 Standard, similarly to the first encoding unit 13 as described in the first embodiment.

The second signal outputting unit 24 is operated to generate subsidiary information by performing the computation represented by Expression 12 on the basis of the frequency domain signal converted by the time-frequency converting unit 21 in accordance with the coefficients stored in the coefficient table selected by the coefficient table selecting unit 26 from among the plurality of coefficient tables 27, as follows. The subsidiary information will be used to reconstruct a multi-channel signal based on the downmixed signal.

$$[ \begin{matrix}a c - b - d \\ c a - d b\end{matrix} ] [ \begin{matrix}L \\ R \\ l \\ r\end{matrix} ] = [ \begin{matrix}aL + cR - bl - dr \\ cL - aR - dl + br\end{matrix} ] \qquad Expression 12$$

Here, the coefficients a, b, c, d are represented in the form of a matrix with (N−2) rows by N columns. In the present embodiment, the coefficients a, b, c, d are represented in the form of a matrix with 2 rows by N columns.

The second encoding unit 25 is operated to encode the subsidiary information outputted from the second signal outputting unit 24, to generate a second coded signal. The second encoding unit 25 may encode the subsidiary information by way of a coding method such as, for example, the MPEG 2 Standard in the same manner as the first encoding unit 23.

The third encoding unit 28 is operated to generate a third coded signal to be used as an index n such as, for example, a table number, indicative of the coefficient table selected by the coefficient table selecting unit 26, simulating transfer characteristics.

The multiplexing unit 29 is operated to multiplex the first coded signal generated by the first encoding unit 23, the second coded signal generated by the second encoding unit 25, and the third coded signal generated by the third encoding unit 28 to generate a bit stream B.

As will be seen from the foregoing description, it will be understood that the present embodiment of the acoustic signal encoding device comprises a plurality of coefficient tables 27 having described therein coefficients for respective frequencies, simulating various kinds of transfer characteristics, a coefficient table selecting unit 26 for selecting a coefficient table from among the plurality of coefficient tables 27 in accordance with an intended usage, a first signal outputting unit 22 for downmixing a N-channel frequency domain signal in accordance with the selected coefficient table to generate a first coded signal constituted by a 2-channel downmixed signal, and a third encoding unit 28 for generating a third coded signal to be used as an index indicative of the coefficient table selected by the coefficient table selecting unit 26. The present embodiment of the acoustic signal encoding device thus constructed can add the index indicative of the coefficient table used to downmix the multi-channel signal to a bit stream to be outputted therethrough, and thus transfer to a decoding device a specific type of a coefficient required to reproduce the multi-channel signal when the multi-channel signal is reproduced, with a small number of bits.

### Third Preferred Embodiment

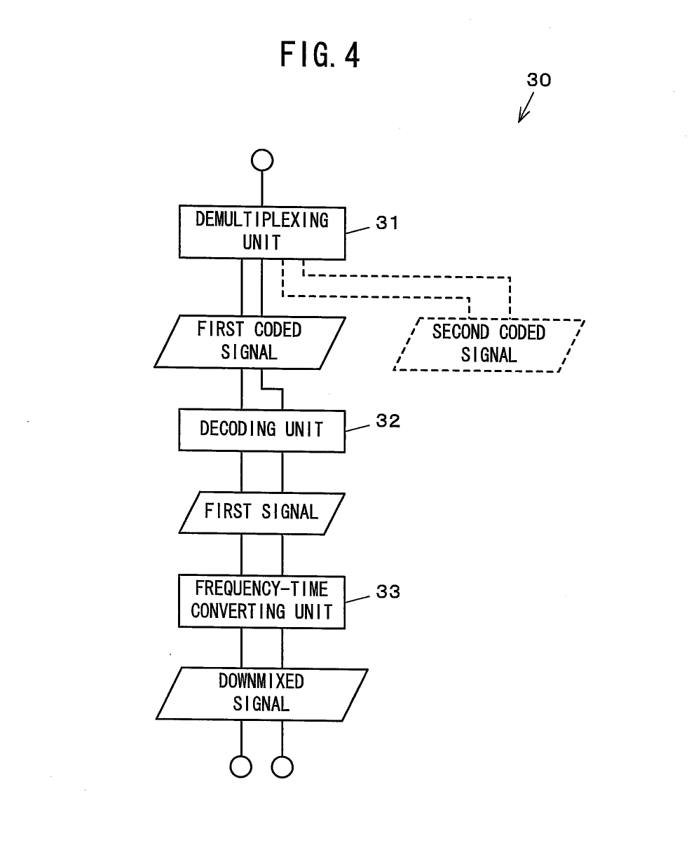

The construction of a third preferred embodiment of the acoustic signal encoding device according to the present invention will be described first with reference to FIG. 4 of the drawings.

As clearly shown in FIG. 4, the present embodiment of the acoustic signal decoding device 30 comprises a demultiplexing unit 31 for demultiplexing a bit stream B multiplexed with the first coded signal and the second coded signal to exclusively extract the first coded signal, i.e., the coded downmixed signal, a decoding unit 32 for decoding the first coded signal into a 2-channel frequency domain acoustic signal as a first signal, and a frequency-time converting unit 33 for converting the first signal into a time domain acoustic signal L′, R′.

Here, the first coded signal is intended to mean a coded signal generated as a result of encoding a downmixed signal, and the second coded signal is intended to mean a coded signal generated as a result of encoding subsidiary information to be used to reconstruct a multi-channel signal based on the downmixed signal.

The operation of the acoustic signal decoding device 30 thus constructed as previously mentioned will be described hereinlater.

The demultiplexing unit 31 is operated to demultiplex a bit stream B (multiplexed with the first coded signal and the second coded signal) generated by the first embodiment of the acoustic signal encoding device 10 or the second embodiment of the acoustic signal encoding device 20 to exclusively extract the first coded signal.

The decoding unit 32 is operated to decode the first coded signal, i.e., the downmixed signal, extracted by the demultiplexing unit 31 into a 2-channel frequency domain downmixed acoustic signal as a first signal L0, R0.

The frequency-time converting unit 33 is operated to convert the first signal L0, R0 decoded by the decoding unit 32 into a time domain acoustic signal L′, R′ by way of, for example, a Fourier Transformation, a Discrete Cosine Transformation, a sub-band filter, and/or the like.

As will be seen from the foregoing description, it will be understood that the present embodiment of the acoustic signal decoding device comprises a demultiplexing unit 31 for demultiplexing a bit stream multiplexed with a downmixed signal and a subsidiary signal to exclusively extract the downmixed signal, and a decoding unit 32 for decoding the downmixed signal into a 2-channel frequency domain acoustic signal. The present embodiment of the acoustic signal decoding device thus constructed can exclusively extract and decode the downmixed signal, without decoding the subsidiary information, and thus reproduce the downmixed signal with a small amount of computation.

### Fourth Preferred Embodiment

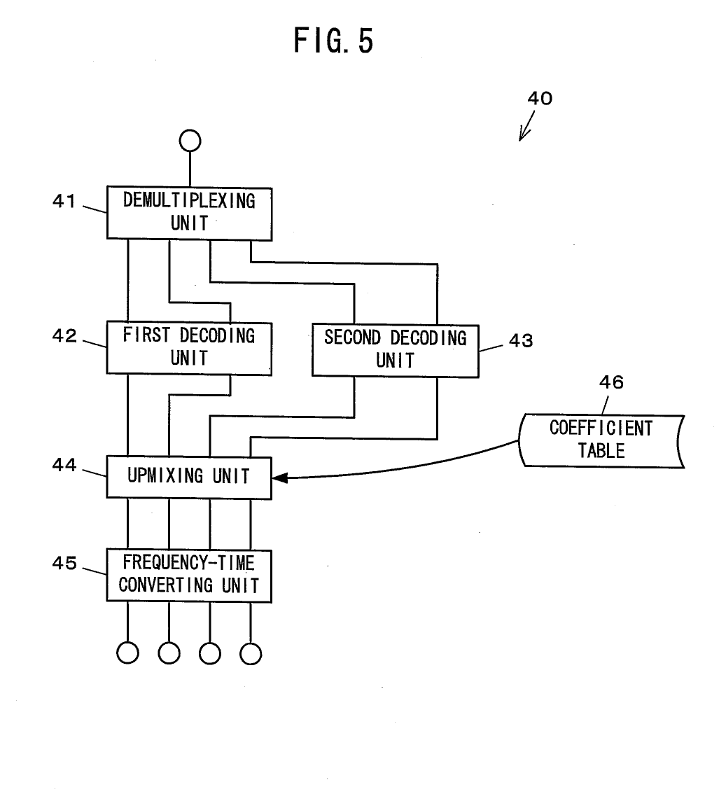

The construction of a fourth preferred embodiment of the acoustic signal encoding device according to the present invention will be described first with reference to FIG. 5 of the drawings.

As clearly shown in FIG. 5, the present embodiment of the acoustic signal decoding device 40 comprises a demultiplexing unit 41 for demultiplexing a bit stream B multiplexed with the first coded signal and the second coded signal to extract the first coded signal, i.e., the coded downmixed signal, and the second coded signal, i.e., the coded subsidiary information, a first decoding unit 42 for decoding the first coded signal into a 2-channel frequency domain acoustic signal as a downmixed signal L0, R0, a second decoding unit 43 for decoding the second coded signal into subsidiary information l0, r0, an upmixing unit 44 for generating a multi-channel signal based on the downmixed signal and the subsidiary information, a frequency-time converting unit 45 for converting the multi-channel signal into a time domain acoustic signal L, R, l, r, and a coefficient table 46 for having described therein coefficients representable in the form of an inverse square matrix of a square matrix with N rows by N columns including coefficients representable in the form of a matrix with 2 rows by N columns simulating head-related transfer characteristics to be applied when the multi-channel signal is reproduced. It is herein assumed that the coefficient table 46 is stored in a storage medium such as, for example, a memory, not shown.

The operation of the acoustic signal decoding device 40 thus constructed as previously mentioned will be described hereinlater.

The demultiplexing unit 41 is operated to demultiplex a bit stream B generated by the first embodiment of the acoustic signal encoding device 10 or the second embodiment of the acoustic signal encoding device 20 to extract the first coded signal and the second coded signal.

The first decoding unit 42 is operated to decode the first coded signal, i.e., the coded downmixed signal, extracted by the demultiplexing unit 41 into a 2-channel frequency domain downmixed acoustic signal as a first signal L0, R0.

The second decoding unit 43 is operated to decode the second coded signal, i.e., the coded subsidiary information, extracted by the demultiplexing unit 41 into subsidiary information, as a second signal l0, r0, to be used to reconstruct a multi-channel signal based on the first signal.

The upmixing unit 44 is operated to generate a multi-channel signal L, R, l, r, based on the first signal L0, R0 generated by the first decoding unit 42 and the second signal l0, r0 generated by the second decoding unit 43 by performing the matrix computation represented by Expression 13 in accordance with the coefficient table 46, as follows.

$$[ \begin{matrix}L \\ R \\ l \\ r\end{matrix} ] = [ \begin{matrix}ax & - cx & ax & - cx \\ - cx & ax & - cx & ax \\ by & - dy & - by & dy \\ - dy & by & dy & - by\end{matrix} ] [ \begin{matrix}L 0 \\ R 0 \\ l 0 \\ r 0\end{matrix} ] \qquad Expression 13$$

Here, x and y can be represented by Expression 14 as follows.

$$x = \frac{1}{2 ( {a}^{2} - {c}^{2} )} \\ y = \frac{1}{2 ( {b}^{2} - {d}^{2} )} \qquad Expression 14$$

Though it has been described in the present embodiment that the storage medium has stored therein only the coefficient table 46, this does not limit the present invention. It is needless to mention that the storage medium may have stored therein a plurality of coefficient tables. In this case, when the bit stream B generated by the second embodiment of the acoustic signal encoding device 20 was reproduced the upmixing unit 44 may obtain from the third coded signal contained in bit stream B an index n indicative of the coefficient table used when the multi-channel signal was downmixed, and select an appropriate coefficient table from among the plurality of coefficient tables stored in the storage medium with reference to the index n.

The frequency-time converting unit 45 is operated to convert the frequency domain multi-channel signal outputted from the upmixing unit 44 into a time domain acoustic signal L, R, l, r, by way of, for example, a Fourier Transformation, a Discrete Cosine Transformation, a sub-band filter, and/or the like.

As will be seen from the foregoing description, it will be understood that the present embodiment of the acoustic signal decoding device comprises a demultiplexing unit 41 for demultiplexing a bit stream to extract downmixed codes and subsidiary codes, an upmixing unit 44 for generating a multi-channel signal based on the downmixed signal and the subsidiary information, and a coefficient table 46 for having described therein coefficients representable in the form of an inverse matrix of a matrix including coefficients representable in the form of a matrix with 2 rows by N columns simulating head-related transfer characteristics to be applied when the multi-channel signal is reproduced. The present embodiment of the acoustic signal decoding device thus constructed can reproduce the original multi-channel signal even though the downmixed signal contains transfer characteristics, because of the fact that the upmixing unit 44 is operative to generate the multi-channel signal with reference to the coefficient table 46.

### Fifth Preferred Embodiment

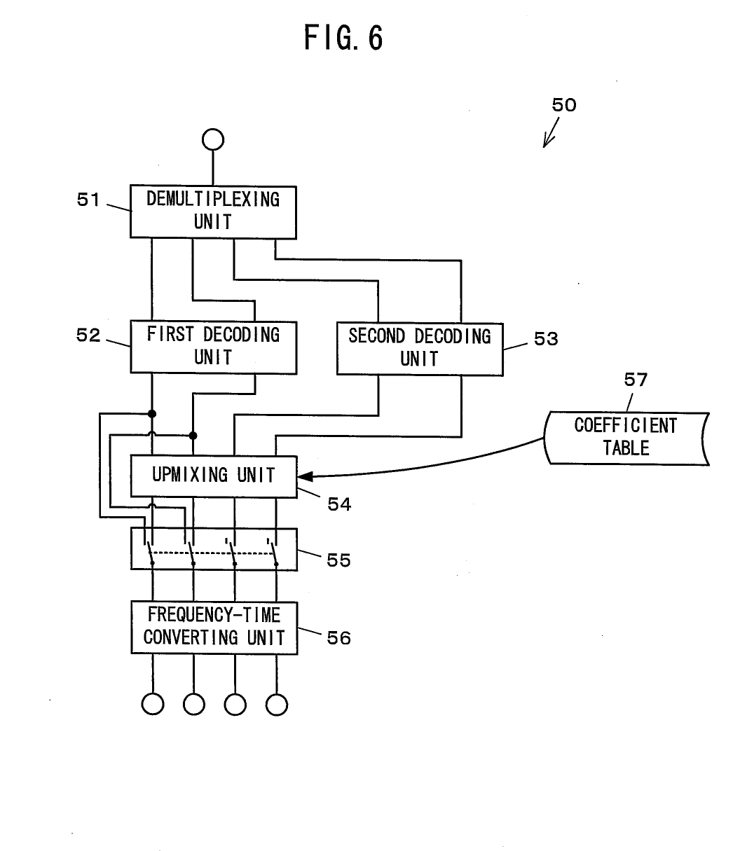

The construction of a fifth preferred embodiment of the acoustic signal encoding device according to the present invention will be described first with reference to FIG. 6 of the drawings.

As clearly shown in FIG. 6, the present embodiment of the acoustic signal decoding device 50 comprises a demultiplexing unit 51 for demultiplexing a bit stream B multiplexed with the first coded signal and the second coded signal to extract the first coded signal, i.e., the coded downmixed signal, and the second coded signal, i.e., the coded subsidiary information, a first decoding unit 52 for decoding the first coded signal into a 2-channel frequency domain acoustic signal as a downmixed signal L0, R0, a second decoding unit 53 for decoding the second coded signal into subsidiary information l0, r0, an upmixing unit 54 for generating a multi-channel signal based on the downmixed signal and the subsidiary information, an outputting channel switching unit 55 for selectively outputting the downmixed signal and the multi-channel signal, a frequency-time converting unit 56 for converting the signal selectively outputted from outputting channel switching unit 55 into a time domain acoustic signal, and a coefficient table 57 for having described therein coefficients representable in the form of an inverse matrix of a square matrix with N rows by N columns including coefficients representable in the form of a matrix with 2 rows by N columns simulating head-related transfer characteristics to be applied when the multi-channel signal is reproduced. It is herein assumed that the coefficient table 57 is stored in a storage medium such as, for example, a memory, not shown.

The operation of the acoustic signal decoding device 50 thus constructed as previously mentioned will be described hereinlater.

The demultiplexing unit 51 is operated to demultiplex a bit stream B generated by the first embodiment of the acoustic signal encoding device 10 or the second embodiment of the acoustic signal encoding device 20 to extract the first coded signal and the second coded signal.

The first decoding unit 52 is operated to decode the first coded signal, i.e., the coded downmixed signal, extracted by the demultiplexing unit 51 into a 2-channel frequency domain downmixed acoustic signal as a first signal L0, R0.

The second decoding unit 53 is operated to decode the second coded signal, i.e., the coded subsidiary information, extracted by the demultiplexing unit 51 into subsidiary information, as a second signal l0, r0, to be used to generate a multi-channel signal based on the first signal.

The upmixing unit 54 is operated to generate a multi-channel signal based on the first signal L0, R0 generated by the first decoding unit 52 and the second signal l0, r0 generated by the second decoding unit 53 by performing the matrix computation in accordance with coefficients aligned in the coefficient table 57. Here, the coefficients aligned in the coefficient table 57 are in the form of an inverse matrix of the matrix as described in the first embodiment. This means that in the case that the first coded signal is generated after downmixing a 4-channel signal, the original 4-channel signal L, R, l, r can be reconstructed by performing the matrix computation represented by Expression 15.

$$[ \begin{matrix}L \\ R \\ l \\ r\end{matrix} ] = [ \begin{matrix}ax & - cx & ax & - cx \\ - cx & ax & - cx & ax \\ by & - dy & - by & dy \\ - dy & by & dy & - by\end{matrix} ] [ \begin{matrix}L 0 \\ R 0 \\ l 0 \\ r 0\end{matrix} ] \qquad Expression 15$$

Here, x and y can be represented by Expression 16 as follows.

$$x = \frac{1}{2 ( {a}^{2} - {c}^{2} )} \\ y = \frac{1}{2 ( {b}^{2} - {d}^{2} )} \qquad Expression 16$$

Though it has been described in the present embodiment that the storage medium has stored therein only the coefficient table 57, this does not limit the present invention. It is needless to mention that the storage medium may have stored therein a plurality of coefficient tables. In this case, when the bit stream B generated by the second embodiment of the acoustic signal encoding device 20 was reproduced the upmixing unit 54 may obtain from third coded signal contained in the bit stream B an index n indicative of the coefficient table used when the multi-channel signal was downmixed, and select an appropriate coefficient table from among the plurality of coefficient tables stored in the storage medium with reference to the index n.

Further, the outputting channel switching unit 55 is operative to selectively output the frequency domain downmixed signal L0, R0 outputted from the first decoding unit 52 and the frequency domain multi-channel signal L, R, l, r outputted from the upmixing unit 54. The outputting channel switching unit 55 may be set to selectively output the frequency domain downmixed signal L0, R0 outputted from the first decoding unit 52 and the frequency domain multi-channel signal L, R, l, r outputted from the upmixing unit 54 in accordance with a usage. The outputting channel switching unit 55 may output the signal L0, R0 outputted from the first decoding unit 52 when, for example, a head phone or a 2 channel speaker unit is used. The outputting channel switching unit 55, on the other hand, may output the signal L, R, l, r outputted from the upmixing unit 54 when, for example, a 4-channel speaker unit is used. This means that the acoustic signal decoding device 50 may include, for example, a detecting unit for detecting a device connected with the output side, and when it is detected that a head phone or a 2-channel speaker unit is connected with the output side, the outputting channel switching unit 55 may be controlled to output the signal L0, R0 outputted from the first decoding unit 52. When, on the other hand, it is detected that a 4-channel speaker unit is connected with the output side, the outputting channel switching unit 55 may be controlled to output the signal L, R, l, r outputted from the upmixing unit 54. In this case, when the downmixed signal L0, R0 is outputted, it is preferable that the second decoding unit 53, the memory having stored therein the coefficient table 57, and the like are turned off to reduce power consumption.

The frequency-time converting unit 56 is operated to convert the frequency domain signal L, R, l, r or L0, R0 outputted from the outputting channel switching unit 55 into a time domain acoustic signal.

As will be seen from the foregoing description, it will be understood that the present embodiment of the acoustic signal decoding device comprises a demultiplexing unit 51 for demultiplexing a bit stream to extract downmixed codes and subsidiary codes, an upmixing unit 54 for generating a multi-channel signal based on the downmixed signal and the subsidiary information, an outputting channel switching unit 55 for selectively outputting the downmixed signal and the multi-channel signal, and a frequency-time converting unit 56 for converting the signal selectively outputted from outputting channel switching unit 55 into a time domain acoustic signal. The present embodiment of the acoustic signal decoding device thus constructed can output the 2-channel downmixed signal when, for example, a head phone or a 2 channel speaker unit is used, and output the multi-channel signal when, for example, a 4-channel speaker unit is used, with the same constituent elements.

While it has been described in the previously mentioned embodiments, that as the multi-channel is used a 4-channel signal, by way of example, this does not limit the present invention. The number of the multi-channel signal may be any number as long as the number of multi-channel signal is equal to or greater than three. It is needless to mention that as the multi-channel signal may be used, for example, a 5.1-channel signal which is widely utilized.

### INDUSTRIAL APPLICABILITY OF THE PRESENT INVENTION

As will be seen from the foregoing description, it will be understood that the acoustic signal encoding device and the acoustic signal decoding device according to the present invention have an effect of making it possible for a downmixed signal to be filtered in accordance with a desired transfer function, thereby enabling the acoustic signal decoding device to reproduce the original multi-channel spatial information simply by reproducing the first coded signal, and the original multi-channel signal by reproducing the first coded signal with the aid of the second coded signal. The fact that the acoustic signal encoding device can downmix and encode a multi-channel signal, and the acoustic signal decoding device can reproduce the 2-channel signal reflecting its original spatial information simply by reproducing the coded downmixed signal, or the original multi-channel signal by reproducing the coded downmixed signal with the aid of the subsidiary information results in the fact that the acoustic signal encoding device and the acoustic signal decoding device are applicable to a potable device such as, for example, an inexpensive decoder, a head phone, and the like, which are especially required to be downsized.

What is claimed is:

1. An acoustic signal encoding device, comprising:
time-frequency converting means for converting an N-channel signal into an N-channel frequency domain signal;
first signal outputting means for downmixing said N-channel frequency domain signal to have a 2-channel downmixed signal outputted therethrough;
second signal outputting means for generating subsidiary information to be used to reconstruct a multi-channel signal based on said 2-channel downmixed signal;
first encoding means for encoding said downmixed signal to generate a first coded signal;
second encoding means for encoding said subsidiary information to generate a second coded signal;
multiplexing means for multiplexing said first coded signal and said second coded signal; and
a coefficient table for having described therein coefficients for respective frequencies collectively indicative of transfer characteristics, and in which
said N is an integer equal to or greater than three,
said coefficient table includes a square matrix with N rows by N columns formed by coefficients representable in the form of a matrix with 2 rows by N columns simulating head-related transfer characteristics to be applied when said multi-channel signal is reproduced and values aligned in the form of a matrix with (N−2) rows by N columns, which are generated after sign-reversing and realigning said coefficients representable in the form of a matrix with 2 rows by N columns,
said first signal outputting means is operative to downmix said N-channel frequency domain signal into said 2-channel downmixed signal in accordance with said coefficient table, and
said second signal outputting means is operative to generate said subsidiary information to be used to reconstruct based on said 2-channel downmixed signal, in accordance with said coefficient table.

2. An acoustic signal encoding device as set forth in claim 1, further comprising:
a plurality of coefficient tables for having described therein coefficients for respective frequencies collectively indicative of a plurality of transfer characteristics different from one another, and
coefficient table selecting means for selecting a coefficient table from among a plurality of coefficient tables in response to a usage, and in which
said multiplexing means is operative to multiplex index information indicative of said coefficient table selected by said coefficient table selecting means, in addition to said first coded signal and said second coded signal.

3. An acoustic signal decoding device, comprising:
demultiplexing means for demultiplexing a bit stream generated by said acoustic signal encoding device as set forth in any one of claim 1 and claim 2 to exclusively extract downmixed codes;
decoding means for decoding said downmixed codes into a 2-channel frequency domain acoustic signal; and
frequency-time converting means for converting said frequency domain acoustic signal into a time domain acoustic signal.

4. An acoustic signal decoding device, comprising:
demultiplexing means for demultiplexing a bit stream generated by said acoustic signal encoding device as set forth in any one of claim 1 and claim 2 to extract downmixed codes and subsidiary information codes;
first decoding means for decoding said downmixed codes into a 2-channel frequency domain acoustic signal as a downmixed signal;
second decoding means for decoding said subsidiary information codes into subsidiary information;
upmixing means for generating a multi-channel signal based on said downmixed signal and said subsidiary information;
frequency-time converting means for converting said multi-channel signal into a time domain acoustic signal; and
a coefficient table for having described therein coefficients representable in the form of an inverse square matrix of a square matrix with N rows by N columns including coefficients representable in the form of a matrix with 2 rows by N columns simulating head-related transfer characteristics to be applied when said multi-channel signal is reproduced, and in which
said upmixing means is operative to generate said multi-channel signal in accordance with said coefficient table.

5. An acoustic signal decoding device as set forth in claim 4, which further comprises:
outputting channel switching means for selectively outputting said downmixed signal and said multi-channel signal, and in which,
said frequency-time converting means is operative to convert said signal selectively outputted from outputting channel switching means into a time domain acoustic signal.

6. An acoustic signal decoding device as set forth in claim 2, in which
said coefficient table includes coefficients simulating spatial transfer characteristics.
